(19) United States
(12) Patent Application Publication
(10) Pub. No.: US 2019/0136562 A1
(43) Pub. Date: May 9, 2019

(54) TILE SHARK

(71) Applicants: Michael Ray Monroe, Corona, CA (US); Denise Monroe, Corona, CA (US)

(72) Inventors: Michael Ray Monroe, Corona, CA (US); Denise Monroe, Corona, CA (US)

(21) Appl. No.: 16/105,512

(22) Filed: Aug. 20, 2018

Related U.S. Application Data
(60) Provisional application No. 62/582,773, filed on Nov. 7, 2017.

(51) Int. Cl. E04H 4/16; A46B 5/00; B08B 17/00; B08B 1/00

(52) U.S. Cl. CPC E04H 4/1609; B08B 1/002; B08B 17/00; A46B 5/0095

(57) ABSTRACT

A tool designed to remove and prevent the buildup of dirt and calcium, as well as hard watermarks on pool tile. The tool includes a 180-degree swivel pole mount handle that attaches to an extendable pole. The tool may include an adjustable arm to allow the scrubbing surface to reach around the edge of the pool and beneath to the tile border along the waterline. The scrubbing surface may include a plate mounted on a swivel (pivotable) with interchangeable scrubbing attachments. The tool may include at last one non-marking caster wheel to allow the tool to be rolled along the deck of the pool without causing any damage. When operated, the tool allows a user to stand upright, rolling the tool along the deck of the pool while the adjustable arm reaches below the deck to bring the scrubbing surface into contact with the tile border along the water line.

### CROSS-REFERENCE TO RELATED APPLICATION(S)

The present application is related to and claims priority to U.S. Provisional Patent Application No. 62/582,773 filed Nov. 7, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of pool related tools of existing art and more specifically relates to pool cleaning accessories.

### RELATED ART

Pools are found in and out of many residential and business buildings. Pools require proper sanitation to maintain the visual clarity of water and to prevent the transmission of infectious waterborne diseases. Sanitation methods include a water filter to remove pollutants, disinfection to kill infectious microorganisms, swimmer hygiene to minimize the introduction of contaminants into pool water, and regular testing of pool water, including chlorine and pH levels. The tile underneath the coping in a swimming pool may be susceptible to the buildup of calcium, as well as dirt, scum and watermarks. This area is difficult to access and hard to clean. Removing this buildup can be expensive. When pool owners and employees attempt to remove the buildup manually, they end up with sore backs and suffer fatigue due to bending over the edge with inefficient cleaners. In order to thoroughly access the tile, individuals have to enter or drain pools. An effective solution is desired.

U.S. Pat. No. 4,542,549 to Hannah R. Keller relates to a swimming pool cleaning device. The described swimming pool cleaning device includes a wheeled hand-propelled scrubbing device for the upper edge portions of swimming pool side walls near the water level. A sponge scrubbing pad is held in a vertical position by a bracket which depends from a wheeled handle. The scrubbing pad can be secured to a detachable plate to facilitate its replacement. A simple mechanism to reciprocate the scrubbing pad vertically during movement of the device can be included and a cleaning liquid dispenser can be provided on the handle of the device for delivering cleaning liquid to the pad.

### SUMMARY OF THE INVENTION

In view of the foregoing disadvantages inherent in the known pool related tools art, the present disclosure provides a novel pool tile cleaning system, entitled ‘Tile Shark’. The general purpose of the present disclosure, which will be described subsequently in greater detail, is to provide an efficient and effective pool tile cleaning means and system.

The present invention provides a tool that reaches around the edge of the pool and beneath to the tile border along the water line. This removes and prevents calcium build-up, dirt, scum, and removes hard water marks from hard to reach areas, such as underneath the coping of a pool. This further eliminates strenuous, time consuming, and often ineffective cleaning efforts. It enables users to clean without the expense of sandblasting or hydro jet and makes preventive maintenance simple and affordable. The present invention affords the capability to clean the tile without bending over, stooping, or kneeling.

A pool tile cleaning system is disclosed herein, the pool tile cleaning system comprising: a pool tile cleaning tool having a handle, a mounting platform assembly, at least one wheel-assembly, an adjustable arm (which allows the plurality of bristles to reach around an edge of a deck of a pool and beneath a tile border along a waterline of the pool), and a removably couplable scrub-brush having a plurality of bristles, a scrub-brush-base, and an attacher (male portion as receivable by a receiver). As designed the mounting platform assembly provides mounting for the at least one wheel-assembly and the handle; the mounting platform assembly is positioned substantially perpendicular to the adjustable arm during use. The pool tile cleaning system is configured to prevent the buildup of dirt and calcium and hard watermarks on tile when used.

According to another embodiment, a method of use for a pool tile cleaning system is also disclosed herein. The method comprises the steps of: step one providing the pool tile cleaning system comprising a pool tile cleaning tool having a handle, a mounting platform assembly, at least one wheel-assembly, an adjustable arm which allows the plurality of bristles to reach around an edge of a deck of a pool and beneath a tile border along a waterline of the pool, and a removably couplable scrub-brush having a plurality of bristles, a scrub-brush-base, and an attaching means; wherein the mounting platform assembly provides mounting for the at least one wheel-assembly and the handle; the mounting platform assembly is positioned substantially perpendicular to the adjustable arm during use, and wherein the pool tile cleaning system is configured to prevent the buildup of dirt and calcium and hard watermarks on tile, step two grasping the handle and manipulating the handle through a 180-degree swivel to manipulate the pool tile cleaning tool in relation to the deck on the pool, and step three cleaning the tile. The method may further comprise the step of removing the removably couplable scrub-brush and replacing as needed.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a pool tile cleaning system, constructed and operative according to the teachings of the present disclosure.

FIG. 1 is a perspective view of the pool tile cleaning tool of the pool tile cleaning system during an ‘in-use’ condition, according to an embodiment of the disclosure.

FIG. 2 is a side view of the pool tile cleaning tool of FIG. 1, according to an embodiment of the present disclosure.

FIG. 3 is a front view of the pool tile cleaning tool of FIG. 1, according to an embodiment of the present disclosure.

FIG. 4 is another perspective view of the pool tile cleaning tool of FIG. 1, according to an embodiment of the present disclosure.

FIG. 5 is a flow diagram illustrating a method of use for the pool tile cleaning tool of the pool tile cleaning system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to pool accessories and more particularly to a pool tile cleaning system as used to improve the efficient and versatile cleaning of pool surfaces and decks.

Generally, ‘Tile Shark’ is a tool designed to remove and prevent the buildup of dirt and calcium, as well as hard watermarks on pool tile. The tool includes a 180-degree swivel pole mount handle that attaches to an extendable pole. The tool may include an adjustable arm to allow the scrubbing surface to reach around the edge of the pool and beneath to the tile border along the waterline. The scrubbing surface may include a plate mounted on a swivel (pivotable) with interchangeable scrubbing attachments. The tool may include at last one non-marking caster wheel to allow the tool to be rolled along the deck of the pool without causing any damage. When operated, the tool allows a user to stand upright, rolling the tool along the deck of the pool while the adjustable arm reaches below the deck to bring the scrubbing surface into contact with the tile border along the water line.

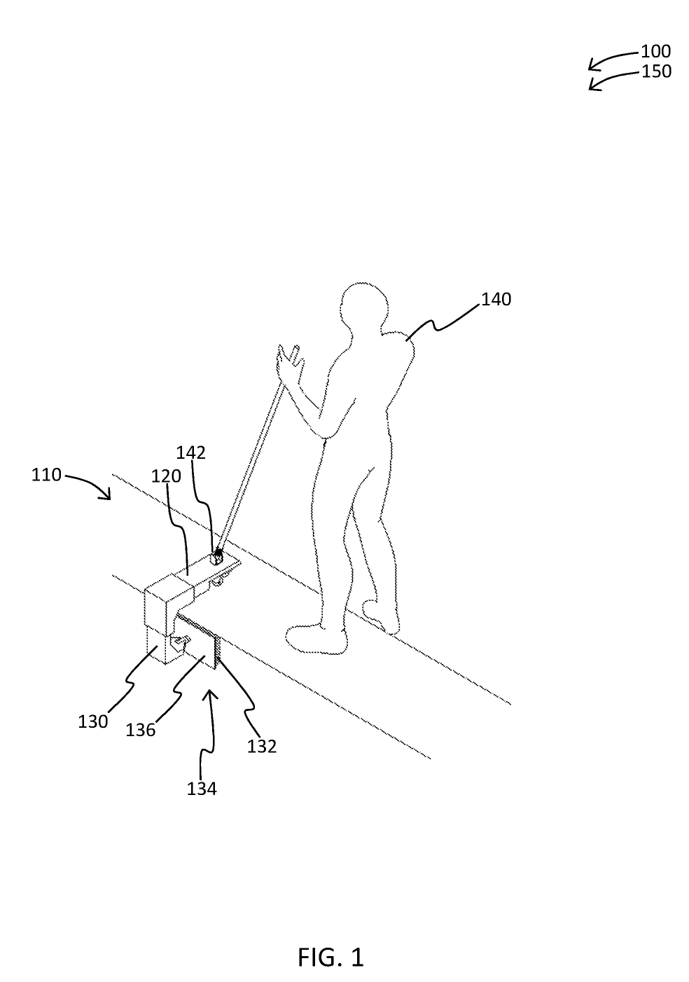

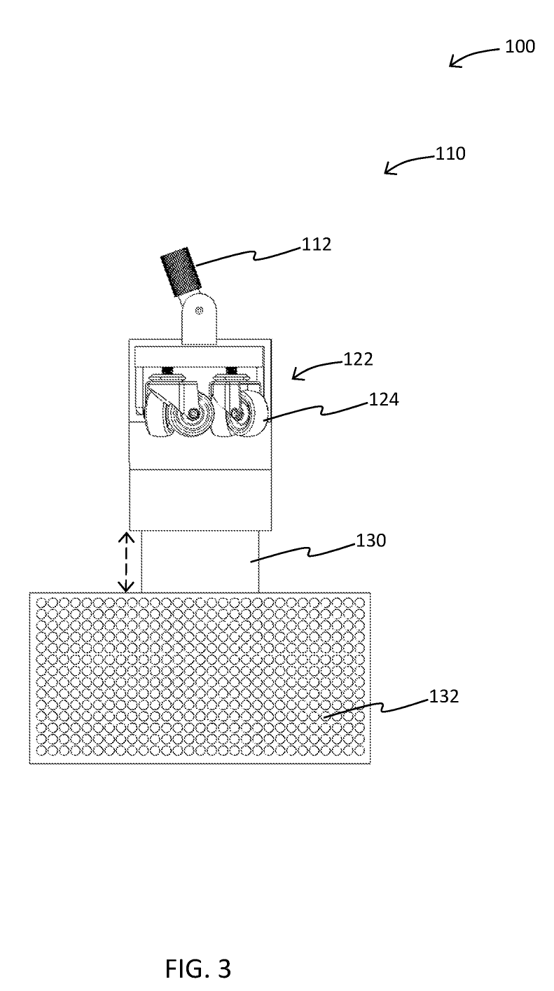

Referring now more specifically to the drawings by numerals of reference, there is shown in FIGS. 1-4, various views of a pool tile cleaning system 100.

FIG. 1 shows a pool tile cleaning system 100 during an ‘in-use’ condition 50, according to an embodiment of the present disclosure. Here, the pool tile cleaning system 100 may be beneficial for use by a user 40 to effectively clean pool tile. As illustrated, the pool tile cleaning system 100 may include a pool tile cleaning tool 110 having a handle 112, a mounting platform assembly 120, at least one wheel-assembly 122, an adjustable arm 130 (which allows the plurality of bristles 132 to reach around an edge of a deck of a pool and beneath a tile border along a waterline of the pool, as shown), and a removably couplable scrub-brush 134 (having a plurality of bristles 132, a scrub-brush-base 136, and an attacher 142); wherein the mounting platform assembly 120 provides mounting for the at least one wheel-assembly 122 and the handle 112; the mounting platform assembly 120 is positioned substantially perpendicular to the adjustable arm 130 during use. As such the pool tile cleaning system 100 is configured to clean the buildup of dirt and calcium and hard watermarks on tile of pools. The adjustable arm 130 preferably comprises an L-shape as shown; the adjustable arm 130 is able to move vertically up and down in relation to the mounting platform assembly 120 in certain embodiments.

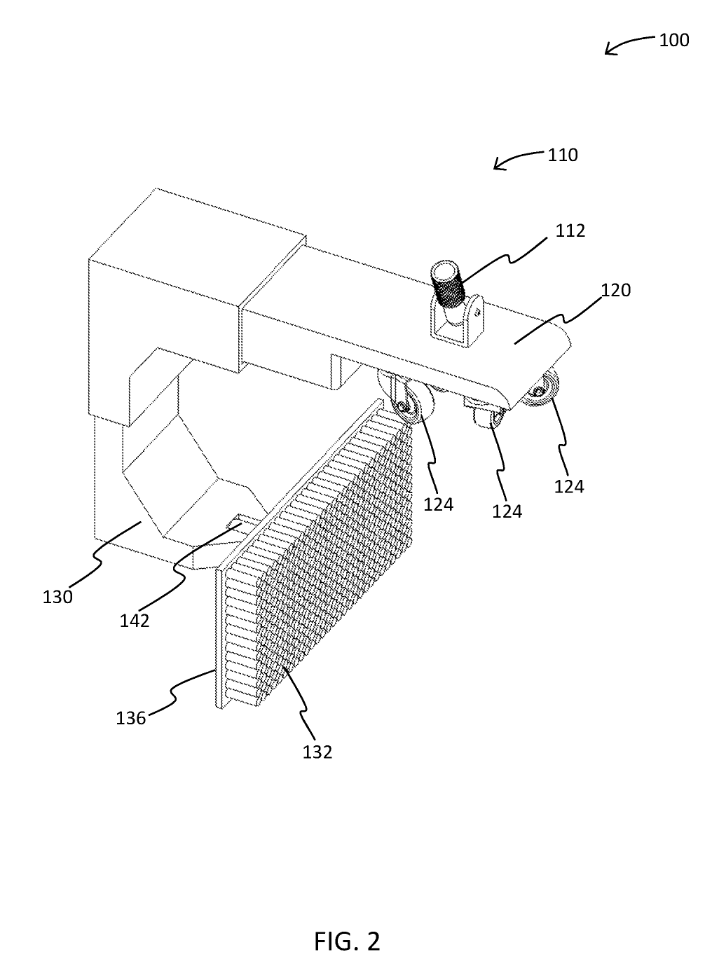

Referring now to the handle 112 of the pool tile cleaning system 100; the handle 112 preferably comprises a 180-degree swivel pole mount version of the handle 112, as shown in FIG. 1. ‘Swivel capability’ is also indicated in FIGS. 2-4; wherein the 180-degree swivel pole mount handle is removably couplable to an extendable pole, as shown in FIG. 1. Other handles 112 and poles may be used and certain embodiments may have poles that telescope for ease of use.

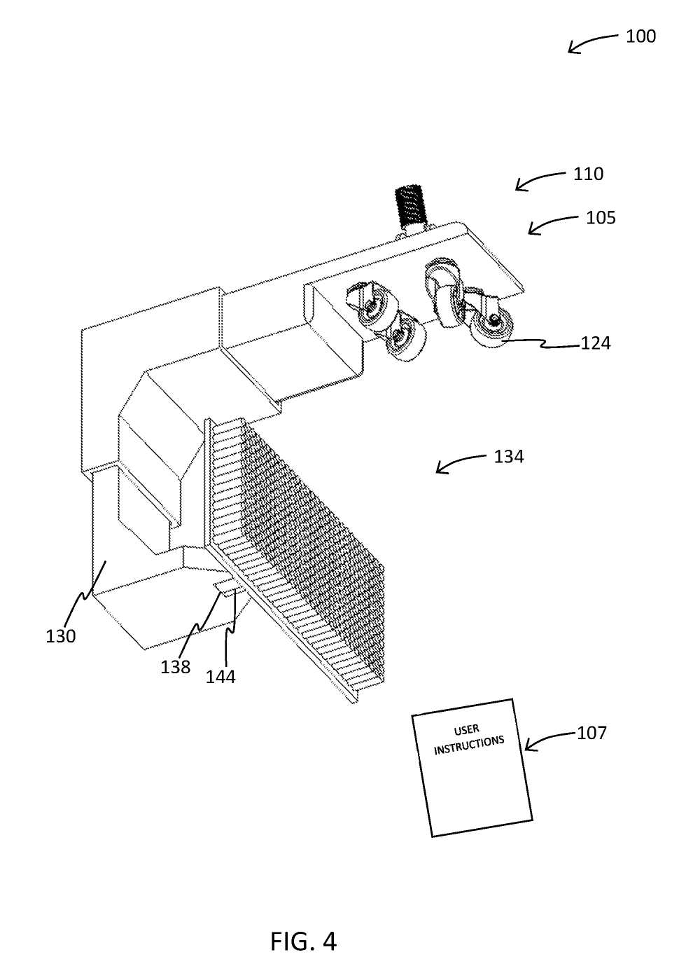

The at least one wheel-assembly 122 of the pool tile cleaning system 100 preferably comprises caster-wheels 124 as shown in FIGS. 2-4; wherein the caster-wheels 124 are non-marking so as to avoid any damage to the pool or ‘marking’ thereof. As designed the pool tile cleaning system 100, when operated, allows a user 40 to stand upright, rolling the pool tile cleaning tool 110 along the deck of the pool while the adjustable arm 130 protrudes below the deck to bring the plurality of bristles 132 into contact with the tile border along the water line for cleaning. The at least one wheel-assembl(ies) 122 are set to engage the deck below a bottom surface of the mounting platform assembly 120, as shown in FIG. 4; wherein the at least one wheel-assembly 122 preferably comprises exactly four the caster-wheels 124.

As previously mentioned, the pool tile cleaning tool 110 comprises the scrub-brush-base 136 comprises a male-insert 144 (as attaching means hereby enabled as attacher 142); wherein the male-insert 144 on the scrub-brush-base 136 is able to be received by a receiver 138 in the adjustable arm 130 in so-enabled embodiments. Relationally speaking, the mounting platform assembly 120 is positioned substantially perpendicular to the scrub-brush-base 136 during use and the mounting platform assembly 120 is also positioned substantially perpendicular to the plurality of bristles 132 during use such that the plurality of bristles 132 are able to effectively engage the pool tiles and the device travel along the decking effectively, as shown in FIG. 1.

The scrub-brush-base 136 is able to pivot slightly within the receiver 138 to allow the plurality of bristles 132 to follow a ‘contour’ of the pool. The pool tile cleaning tool 110 is manually operable in preferred embodiments however other versions may be non-manual in operation. Pressure against the tile surface is obtained by utilizing outward manual force in conjunction with either the swiveling pole platform or swiveling, non-marking caster wheel(s) or both, while the pivoting brush attachment remains in constant contact with tile surface and contour of pool. Those with ordinary skill in the art will now appreciate that upon reading this specification and by their understanding the art of driving pool accessories as described herein, methods of powering and driving and use will be understood by those knowledgeable in such art.

According to one embodiment, the pool tile cleaning system 100 may be arranged as a kit 105. In particular, the pool tile cleaning system 100 may further include a set of instructions 107. The instructions 107 may detail functional relationships in relation to the structure of the pool tile cleaning system 100 such that the pool tile cleaning system 100 can be used, maintained, or the like, in a preferred manner.

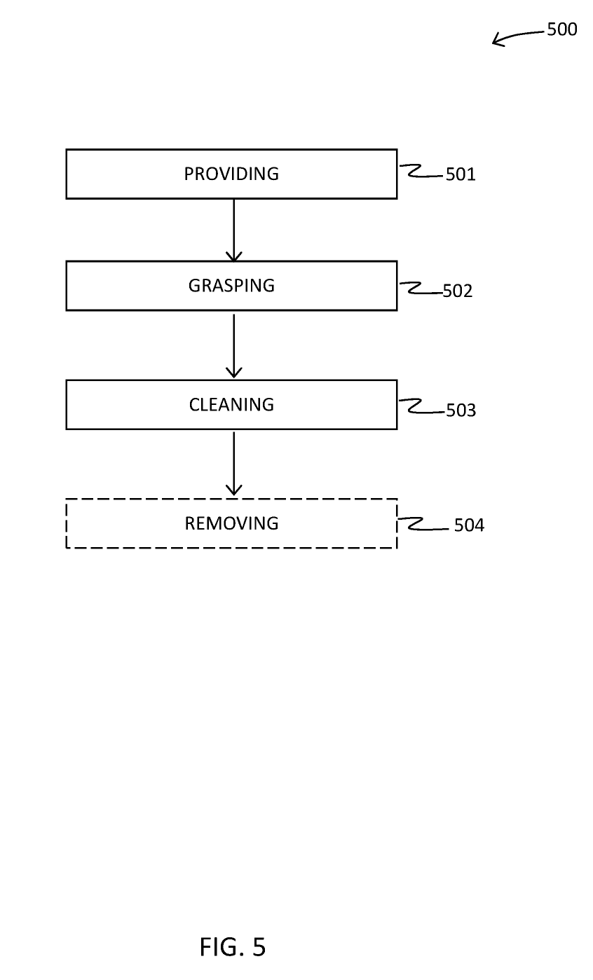

FIG. 5 is a flow diagram illustrating a method for using 500 the pool tile cleaning system 100, according to an embodiment of the present disclosure. In particular, the method for use 500 may include one or more components or features of the pool tile cleaning system 100 as described above. As illustrated, the method for use 500 may include the steps of: step one 501, providing the pool tile cleaning system comprising a pool tile cleaning tool having a handle, a mounting platform assembly, at least one wheel-assembly, an adjustable arm which allows the plurality of bristles to reach around an edge of a deck of a pool and beneath a tile border along a waterline of the pool, and a removably couplable scrub-brush having a plurality of bristles, a scrub-brush-base, and an attaching means; wherein the mounting platform assembly provides mounting for the at least one wheel-assembly and the handle, the mounting platform assembly is positioned substantially perpendicular to the adjustable arm during use, and wherein the pool tile cleaning system is configured to prevent the buildup of dirt and calcium and hard watermarks on tile, step two 502 grasping the handle and manipulating the handle through a 180-degree swivel to manipulate the pool tile cleaning tool in relation to the deck on the pool, and step three 503 cleaning (manually) the tile. The method may further comprise the step four 504 of removing the removably couplable scrub-brush and replacing as needed.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using the pool tile cleaning system 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A pool tile cleaning system, the pool tile cleaning system comprising:
a pool tile cleaning tool having;
a handle;
a mounting platform assembly;
at least one wheel-assembly;
an adjustable arm which allows a plurality of bristles to reach around an edge of a deck of a pool and beneath a tile border along a waterline of said pool; and
a removably couplable scrub-brush having;
the plurality of bristles;
a scrub-brush-base; and
an attacher;
wherein said mounting platform assembly provides mounting for said at least one wheel-assembly and said handle, said mounting platform assembly is positioned substantially perpendicular to said adjustable arm during use; and
wherein the pool tile cleaning system is configured to prevent the buildup of dirt and calcium and hard watermarks on tile.

2. The pool tile cleaning system of claim 1, wherein said handle comprises a 180-degree swivel pole mount said handle.

3. The pool tile cleaning system of claim 2, wherein said 180-degree swivel pole mount said handle is removably couplable to an extendable pole.

4. The pool tile cleaning system of claim 3, wherein said at least one wheel-assembly comprises caster-wheels.

5. The pool tile cleaning system of claim 4, wherein the caster-wheels are non-marking so as to avoid any damage to said pool.

6. The pool tile cleaning system of claim 5, wherein the pool tile cleaning system, when operated, allows a user to stand upright, rolling the pool tile cleaning tool along the deck of the pool while the adjustable arm protrudes below the deck to bring the plurality of bristles into contact with the tile border along the water line.

7. The pool tile cleaning system of claim 6, wherein the scrub-brush-base comprises a male-insert.

8. The pool tile cleaning system of claim 7, wherein the male-insert on said scrub-brush-base is able to be received by a receiver in said adjustable arm.

9. The pool tile cleaning system of claim 8, wherein said mounting platform assembly is positioned substantially perpendicular to said scrub-brush-base during use.

10. The pool tile cleaning system of claim 9, wherein said mounting platform assembly is positioned substantially perpendicular to said plurality of bristles during use.

11. The pool tile cleaning system of claim 10, wherein the adjustable arm comprises an L-shape.

12. The pool tile cleaning system of claim 11, wherein the adjustable arm is able to move vertically up and down in relation to said mounting platform assembly.

13. The pool tile cleaning system of claim 8, wherein said scrub-brush-base is able to pivot slightly within said receiver to allow said plurality of bristles to follow a contour of said pool.

14. The pool tile cleaning system of claim 1, wherein the pool tile cleaning tool is manually operable.

15. The pool tile cleaning system of claim 1, wherein the at least one wheel-assembly are set to engage the deck below a bottom surface of the mounting platform assembly.

16. The pool tile cleaning system of claim 4, wherein the at least one wheel-assembly comprises exactly four said caster-wheels.

17. A pool tile cleaning system, the pool tile cleaning system comprising:
a pool tile cleaning tool having;
a handle;
a mounting platform assembly;
at least one wheel-assembly;
an adjustable arm which allows a plurality of bristles to reach around an edge of a deck of a pool and beneath a tile border along a waterline of said pool; and
a removably couplable scrub-brush having;
the plurality of bristles;
a scrub-brush-base; and
an attacher;
wherein said handle comprises a 180-degree swivel pole mount said handle;
wherein said 180-degree swivel pole mount said handle is removably couplable to an extendable pole;
wherein said mounting platform assembly provides mounting for said at least one wheel-assembly and said handle, said mounting platform assembly is positioned substantially perpendicular to said adjustable arm during use;
wherein said at least one wheel-assembly comprises caster-wheels;
wherein the caster-wheels are non-marking so as to avoid any damage to said pool;
wherein the at least one wheel-assembly comprises exactly four said caster-wheels;
wherein the at least one wheel-assembly are set to engage the deck below a bottom surface of the mounting platform assembly;
wherein the scrub-brush-base comprises a male-insert;
wherein the male-insert on said scrub-brush-base is able to be received by a receiver in said adjustable arm;
wherein the adjustable arm comprises an L-shape;
wherein the adjustable arm is able to move vertically up and down in relation to said mounting platform assembly;
wherein said mounting platform assembly is positioned substantially perpendicular to said scrub-brush-base during use;
wherein said mounting platform assembly is positioned substantially perpendicular to said plurality of bristles during use;
wherein the pool tile cleaning system, when operated, allows a user to stand upright, rolling the pool tile cleaning tool along the deck of the pool while the adjustable arm protrudes below the deck to bring the plurality of bristles into contact with the tile border along the water line;
wherein the pool tile cleaning tool is manually operable; and
wherein the pool tile cleaning system is configured to prevent the buildup of dirt and calcium and hard watermarks on tile.

18. The pool tile cleaning system of claim 17, further comprising set of instructions; and
wherein the pool tile cleaning system is arranged as a kit.

19. A method of use for a pool tile cleaning system, the method comprising the steps of:
providing the pool tile cleaning system comprising;
a pool tile cleaning tool having;
a handle;
a mounting platform assembly;
at least one wheel-assembly;
an adjustable arm which allows the plurality of bristles to reach around an edge of a deck of a pool and beneath a tile border along a waterline of said pool; and
a removably couplable scrub-brush having;
a plurality of bristles;
a scrub-brush-base; and
an attacher;
wherein said mounting platform assembly provides mounting for said at least one wheel-assembly and said handle, said mounting platform assembly is positioned substantially perpendicular to said adjustable arm during use; and
wherein the pool tile cleaning system is configured to prevent the buildup of dirt and calcium and hard watermarks on tile;
grasping said handle and manipulating said handle through a 180-degree swivel to manipulate said pool tile cleaning tool in relation to the deck on the pool; and
cleaning said tile.

20. The method of claim 19, further comprising the step of:
removing said removably couplable scrub-brush and replacing as needed.
